(19) United States
(12) Patent Application Publication
(10) Pub. No.: US 2016/0164845 A1
(43) Pub. Date: Jun. 9, 2016

(54) IMPLEMENTING NETWORK COMMUNICATION

(71) Applicant: HANGZHOU H3C TECHNOLOGIES CO., LTD., Hangzhou, Zhejiang (CN)

(72) Inventor: Yu MAO, Beijing (CN)

(73) Assignee: Hangzhou H3C Technologies Co., ltd., Hangzhou City (CN)

(21) Appl. No.: 14/899,759

(22) PCT Filed: Aug. 27, 2014
(86) PCT No.: PCT/CN2014/085265

§ 371 Date: Dec. 18, 2015

(30) Foreign Application Priority Data
Aug. 30, 2013 (CN) 201310390910.0

(51) Int. Cl. H04L 29/06

(52) U.S. Cl. CPC H04L 63/0428; H04L 63/0227; H04L 63/0272

(57) ABSTRACT

When a node device receives a packet transmitted from a device connecting with the node device, the node device searches a public network address of a next hop in a first table according to a private address of the next hop, searches for an IPsec security association (SA) in a second table according to the public network address searched out, performs IPsec encapsulation for the received packet by use of the IPsec SA corresponding to the public network address, and transmits the packet.

### BACKGROUND

More and more companies establish a virtual private network (VPN) by use of a public network to connect multiple branches of the companies in different geographical locations. The branches of the companies usually access the public network via dynamic addresses.

Through a dynamic virtual private network (DVPN) technology, information such as public network addresses dynamically changed can be collected, maintained and distributed through a next hop resolution protocol (NHRP) or a VPN Address Management (VAM) protocol. In the condition that various branches in companies access the public network by use of dynamic addresses, the VPN can be established among the branches through the DVPN technology.

### BRIEF DESCRIPTION OF THE DRAWINGS

FIG. 1 is a schematic diagram illustrating a structure of a DVPN according to an example of the present disclosure;

FIG. 2 is a flowchart illustrating a method for implementing network communication according to an example of the present disclosure;

FIG. 3 is a schematic diagram illustrating a format of an IPsec packet according to an example of the present disclosure;

FIG. 4 is a schematic diagram illustrating a structure of an apparatus for implementing network communication according to an example of the present disclosure;

FIG. 5 is another schematic diagram illustrating a structure of a DVPN according to an example of the present disclosure.

### DETAILED DESCRIPTION

In order to make the object, technical solution and merits of the present disclosure clearer, the present disclosure will be illustrated in detail hereinafter with reference to the accompanying drawings and specific examples.

A DVPN takes a network including various nodes connecting with a public network as a VPN network. Each Spoke device dynamically accesses the public network. A public address of the Spoke device is un-known for the other communication end. The public address is one of necessary conditions for establishing an end-to-end security tunnel.

In the DVPN, the public address of the other communication end may be obtained through a VAM protocol. Through the VAM protocol, information such as the public address may be collected, maintained, and distributed to help users conveniently establish an internal security tunnel. A next hop in a private network of a data packet forwarded in a company internal network through a routing protocol. A public address corresponding to the next hop in the private network may be queried through the VAM protocol. The public address is taken as a target address of the tunnel to perform encapsulation. The data packet is transmitted to a user in a target end through the established security tunnel.

When registering to a VAM server, a VAM client obtains a role such as a Spoke or a Hub. A node device obtaining the Spoke role is taken as a Spoke device, a node device obtaining the Hub role is taken as a Hub device. When receiving a packet from a computing device, a Spoke device encapsulates the packet into a Generic Routing Encapsulation (GRE) packet, and then searches for an IPsec SA corresponding to the public network address according to information of the GRE packet. When the IPsec SA corresponding to the public network address is obtained, the Spoke device encapsulates the GRE packet according to the IPsec SA searched out, and transmits the GRE packet to the next hop. The information of the GRE packet may include a source IP address, a target IP address and a protocol number. When the packet is encapsulated into a User Datagram Protocol (UDP) packet, the information of the UDP packet may further include a source port number and a target port number.

A Spoke device of the next hop performs IPsec decapsulation for the received packet, performs GRE decapsulation for the packet, and forwards the packet to a Spoke device in another next hop or a target computing device according to a target IP address of the decapsulated packet.

According to the method above, in the VPN, the packet may be encapsulated through IPsec and GRE or through IPsec and UDP. Thus, DVPN communication is performed according to another network protocol, e.g., the GRE protocol and the UDP protocol.

A method for implementing network communication is provided according to an example of the present disclosure. When receiving a packet from a device connecting with a node device and obtaining a public address of the other end, a node device in the DVPN searches for a corresponding IPsec SA according to the public address, directly encapsulates the packet according to the IPsec SA searched out, and transmits the packet. In an example, the packet may be transmits via a DVPN Point-to-MultiPoint (P2MP) interface in the node device so as to reduce a size of the packet and decrease network bandwidth consumption.

In an example, a client in the DVPN registers to a control server. After performing registering, the client obtain a role such as a Spoke or a Hub. In the following description, a node device obtaining the Spoke role is taken as a Spoke device, a node device obtaining the Hub role is taken as a Hub device.

FIG. 2 is a flowchart illustrating a method for implementing network communication according to an example of the present disclosure. The method includes procedures as follows.

At block 301, a node device receives a packet transmitted from a device connecting with the node device.

In an example, the node device may be located in the DVPN. At the block, when receiving the packet transmitted from the device connecting with the node device, the node device obtains a next hop and an output interface from a routing table according to a target IP address of the packet. In an example, the output interface may be the DVPN P2MP interface. The packet is transmitted to the DVPN P2MP interface at first.

At block 302, According to the obtained next hop, the node device searches for a public network address corresponding to the next hop in a first table, searches for an IPsec SA corresponding to the next hop from a second table, performs IPsec encapsulation for the received packet, and transmits the packet.

The first table may include at least one entry of a map between a private address and a public address of the next hop, e.g., a section table, a P2P table. The second table may include at least one entry of a map between a public network address and an IPsec SA, e.g., an IPsec table.

In an example, on the DVPN P2MP interface, a public address corresponding to a next hop is searched for according to the obtained next hop in the first table. When the public address corresponding to the next hop is searched out, the IPsec SA corresponding to the next hop is searched for in the second table according to public network address searched out. When the public address corresponding to the next hop is not searched out, i.e., an entry between the private address and the public address of the next hop has not been established in the first table, establishment of the entry in the first table is triggered, which includes procedures as follows.

The node device queries a public network address corresponding to the next hop to a control server, and establishes the entry in the first table in local, wherein content of the entry in the first table includes the private address and the public network address of the next hop.

In an example, through a VAM protocol or a Next Hop Resolution Protocol (NHRP), the node device queries the public network address corresponding to the next hop to the control server.

Each client has registered to the control server. The public network address may be dynamically changed. The private network address is static and is not changed. Thus, the private network address and the current public network address may be obtained from the control server.

After establishing the entry between the private network address and the public network address of the next hop in the first table, the node device triggers to perform IKE negotiation with the node device corresponding to the public network address, and generates an entry corresponding to the public network address in the second table. In a process of performing the IKE negotiation, the node device fills an any-to-any packet into information of protected data stream. Thus, the IPsec SA may be searched out according to the public address.

The method for performing IKE negotiation provided according to an example of the present disclosure may be applied between a Spoke device and a Hub device or between two Spoke devices. When there are multiple Hub devices, the method for performing IKE negotiation provided according to an example of the present disclosure may be applied between two Hub devices.

In the second table, the IPsec SA may be searched out through the public network address of the other communication end as an index, or through information of a GRE packet or a UDP packet. Content of the IPsec SA may be obtained by performing the IKE negotiation. An entry in the second table may be established by taking the public network address of the other end as the index. Thus, in a process of performing the IKE negotiation, the node device fills the any-to-any packet into information of protected data stream.

In an example, the node device searches for the IPsec SA corresponding to the next hop in the second table according to the public network address searched out. When the node device searches out the IPsec SA corresponding to the next hop in the second table, the node device and the other end have performed the IKE negotiation, i.e., the IPsec tunnel is established, the packet may be directly encapsulated, and transmitted. When the node device does not search out the IPsec SA in the second table, the node device triggers to perform the IKE negotiation. A process of performing the IKE negotiation includes procedures as follows.

The node device performs the IKE negotiation with a node device corresponding to the public address, and generates an entry corresponding to the public network address in the second table. In the process of performing the IKE negotiation, the node device fills an any-to-any packet into information of protected data stream.

In the process of performing the IKE negotiation between the node device and a node device in the other communication end, the node device fills the any-to-any packet into information of protected data stream in the original negotiation packet. When the entry in the second table is established, the public network address is used as the IPsec SA.

In an example, when the node device is a Spoke device and the public network address is not searched out in the first table according to the obtained next hop, the received packet is forwarded via a Hub device. When the node device is a Spoke device and the IPsec SA is not searched out according to the public network address searched out, the received packet is forwarded via a Hub device.

When the packet is forwarded via the Hub device, a public network address of the Hub device is obtained from the first table. The IPsec SA of the next hop is searched for in the second table according to the public network address of the Hub device. When the IPsec SA is searched out in the second table, the node device performs IPsec encapsulation for the received packet by use of the IPsec SA searched out. When the IPsec SA is not searched out in the second table, the node device triggers to perform IKE negotiation with the Hub device.

When the node device is a Hub device and the public network address is not searched out in the first table according to the obtained next hop, the received packet is discarded. When the node device is a Hub device and the IPsec SA is not searched out in the second table according to the public network address searched out, the received packet is discarded. When the packet transmitted from the Hub device may be forwarded by another Hub device according to a structure of the DVPN and a map between each Hub and each Spoke, the packet is not discarded. Thus, the original data packet may be directly encapsulated into the IPsec packet between two node devices communicating with each other in the DVPN.

FIG. 2 is a flowchart illustrating a method for implementing network communication according to an example of the present disclosure. A process after the IPsec packet is received may include procedures as follows.

When the node device receives an IPsec packet from another node device and a target IP address of the IPsec packet is the IP address of the node device, the node device decapsulates the IPsec packet, and forwards the decapsulated packet according to the target IP address of the IPsec packet. Otherwise, the node device forwards the IPsec packet according to the target IP address of the IPsec packet.

When the node device is a Hub device and the target IP address of the decapsulated packet is not an IP address of a device connecting with the Hub device, and is an IP address of a device connecting with another node device, the packet is re-encapsulated according to the second table and is forwarded to the another node device.

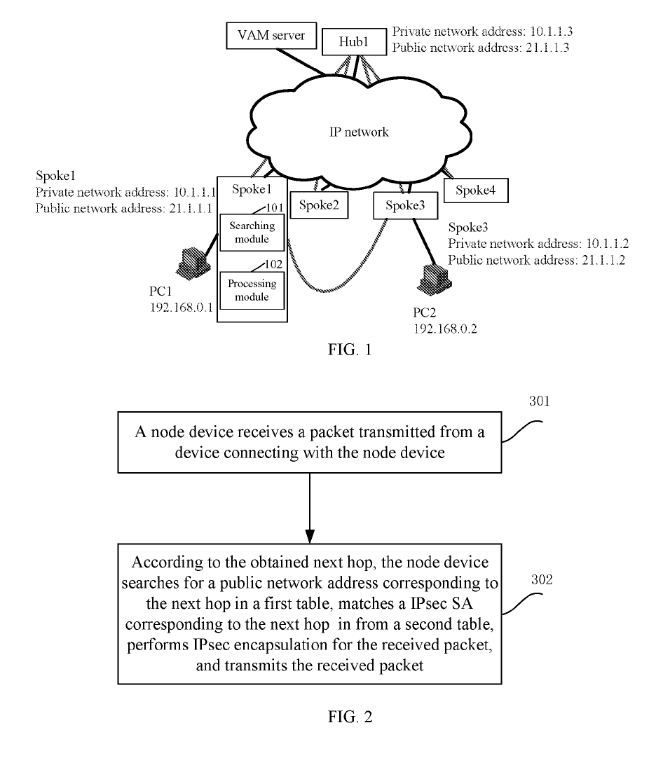

FIG. 1 is a schematic diagram illustrating a method for implementing network communication according to an example of the present disclosure. In FIG. 1, a server of a VAM protocol, referred as to a VAM server, is taken as an example of a control server.

After establishing an entry corresponding to a public network address of a Hub1 in a P2P table in local, a Spoke1 may trigger to establish an entry in an IPsec table, i.e., to establish an IPsec tunnel. An IPsec SA corresponding to the Hub1 may be searched out in the IPsec table according to the public network address of the Hub1.

In FIG. 1, it is taken as an example that a PC1 transmits a data packet to a PC2. The PC1 encapsulates the data packet with a source IP address 192.168.0.1 and a target IP address 192.168.0.2, and transmits the data packet to the Spoke1.

When receiving the original data packet, the Spoke1 searches for a next hop and an output interface in a routing table in local according to the target IP address 192.168.0.2. The next hop searched out is a private network address of a Spoke3, i.e., a tunnel address 10.1.1.2. The output interface is a DVPN P2MP interface. Afterwards, the original data packet is transmitted to the DVPN P2MP interface.

On the DVPN P2MP interface, the Spoke1 searches for a public network address of the next hop in the P2P table in local according to the obtained private network address 10.1.1.2 of the next hop.

When the local P2P table includes the public address 21.1.1.2 corresponding to 10.1.1.2, an entry corresponding to the Spoke 3 has been established in the P2P table. A searching module 101 searches for the IPsec SA in a local IPsec table according to the public network address. When the searching module 101 searches out the IPsec SA, the Spoke1 has performed IKE negotiation with the Spoke3 and the entry corresponding to the Spoke 3 has been established in the IPsec table, i.e., the IPsec tunnel has been established. A processing module 102 encapsulates the received original data packet by use of the IPsec SA searched out. FIG. 3 is a schematic diagram illustrating a format of an IPsec packet according to an example of the present disclosure. In FIG. 3, the source IP address of the IPsec packet is the public network address 21.1.1.1 of the Spoke1, the target IP address of the IPsec packet is the public network address 21.1.1.2 of the Spoke3. The modules may be implemented by hardware. The hardware may include hardware logic circuitry such as an application specific integrated chip (ASIC) or field programmable gate array (FPGA) or a general purpose processor such as a central processing unit (CPU) for executing instructions.

The Spoke1 transmits the encapsulated IPsec packet via the tunnel established with the Spoke3.

When receiving the IPsec packet and determining that the target IP address of the IPsec packet is the public network IP address of the Spoke3, the Spoke3 decapsulates the IPsec packet. The target IP address of the decapsulated packet is 192.168.0.2. The decapsulated packet is transmitted to the PC2 corresponding to the target IP address.

When there is not an entry corresponding to 10.1.1.2 in the local P2P table, i.e., the public network address corresponding to 10.1.1.2 is not searched out in the Spoke1, the public network address 10.1.1.2 of the next hop is obtained from the VAM server through the VAM protocol, and an entry corresponding to 10.1.1.2 and 21.1.1.2 is established in the P2P table.

After the entry in the P2P table is established, the Spoke1 triggers the IKE negotiation with the Spoke3. In a process of performing the IKE negotiation, the Spoke1 fills information of protected data stream with a packet any to any. After the IKE negotiation is performed, an entry corresponding to the public network address of the Spoke3 in the IPsec table is established. The Spoke1 may directly transmit a packet to the Spoke3.

When the IPsec SA corresponding to the public network address of the Spoke3 is not searched out in the IPsec table, the Spoke 1 triggers to perform the IKE negotiation with the Spoke 3.

When there is not an entry corresponding to 10.1.1.2 in the P2P table, i.e., the public network address corresponding to 10.1.1.2 is not searched out in the Spoke1, the original data packet may be forwarded through a Hub1. When the IPsec SA corresponding to the public network address of the Spoke3 is not searched out in the IPsec packet, the original data packet may be forwarded through a Hub1.

The Spoke1 searches for the public network address 21.1.1.3 corresponding to 10.1.1.3 in the local P2P table, and searches for the IPsec SA according to 21.1.1.3 in the IPsec table, encapsulates the received packet by use of the IPsec SA, and transmits the packet.

When receiving the IPsec packet transmitted from the Spoke1, since the target IP address is same with that of the Hub1, the Hub1 decapsulates the IPsec packet, obtains the next hop according to the target IP address of the decapsulated packet, i.e., the private network address of the Spoke3, searches for the public network address of the Spoke3 in the P2P table according to the next hop, searches for the IPsec SA in the IPsec table according to the public network address, and encapsulates the packet by use of the IPsec SA searched out, and transmits the packet to the Spoke 3.

The Hub 1 has established an entry corresponding to the private network address of each Spoke device in the P2P table, has triggered the IKE negotiation, and has establish an entry corresponding to the public network address in the IPsec table. The process of establishing the entry in the IPsec table with the Spoke device is similar with that of establishing the entry in the P2P table with the Spoke device, which is not described repeatedly herein.

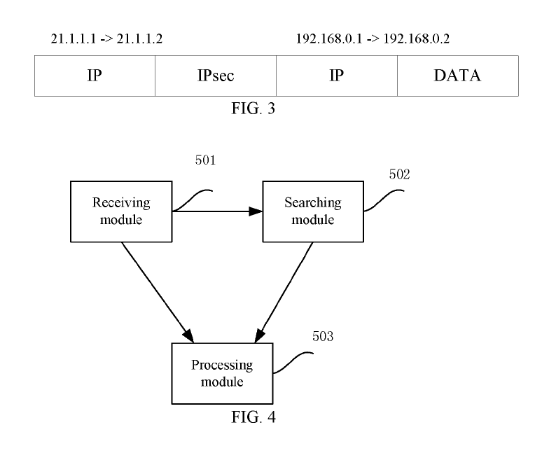

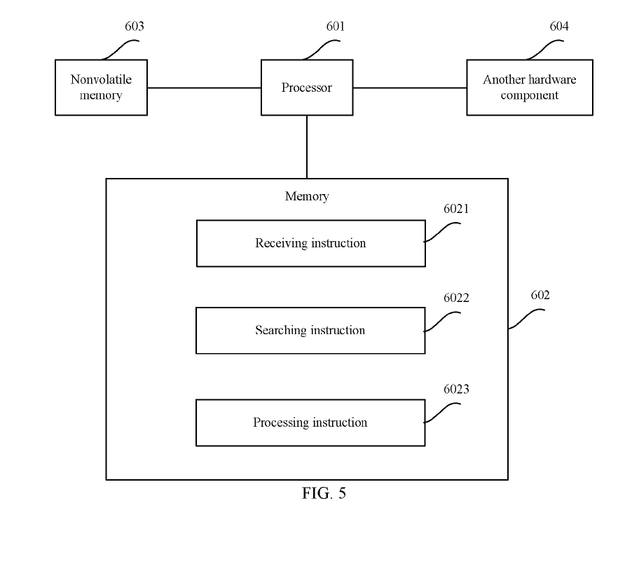

An apparatus for implementing network communication is provided according to an example of the present disclosure, and applies to a node device in a DVPN. FIG. 4 is a schematic diagram illustrating a structure of a network communication apparatus according to an example of the present disclosure. The apparatus includes a receiving module 501, a searching module 502 and a processing module 503. The modules may be implemented by hardware. The hardware may include hardware logic circuitry such as an application specific integrated chip (ASIC) or field programmable gate array (FPGA) or a general purpose processor such as a central processing unit (CPU) for executing instructions.

The receiving module 501 is to receive a packet transmitted from a device connecting with the apparatus.

The searching module 502 is to when the receiving module 501 receives a packet transmitted from a device connecting with the apparatus, search for a public network address of a next hop in a first table according to a private address of the next hop, search for an IPsec security association (SA) in a second table according to the public network address searched out.

In an example, the packet may be transmitted via a DVPN P2MP interface on the apparatus. The next hop may be obtained according to a target IP address of the received packet.

The processing module 503 is to perform IPsec encapsulation for the received packet by use of the IPsec SA searched out.

The first table may include at least one entry of a map between a private address and a public address of the next hop, e.g., a section table, a P2P table. The second table may include at least one entry of a map between a public network address and an IPsec SA, e.g., an IPsec table.

The processing module 503 is further to when the public network address is not searched out from the first table according to the private address of the next hop, query the public network address of the next hop to a VAM server through a VAM protocol, add an entry of a map between the private network address and the public network address of the next hop into the first table, triggers to perform the IKE negotiation with a node device corresponding to the public network address to obtain the IPsec SA corresponding to the public network address, add an entry of a map between the public network address and the obtained IPsec SA into the first table. In a process of performing the IKE negotiation, the processing module 503 fills an any-to-any packet into information of protected data stream. Thus, the IPsec SA may be searched out according to the public address.

The processing module 503 is further to when the IPsec SA corresponding to the public network address is not searched out in the second table, triggers to perform the IKE negotiation with a node device corresponding to the public network address to obtain the IPsec SA corresponding to the public network address, establishes an entry of a map between the public network address and the IPsec SA in the second table. In a process of performing the IKE negotiation, the processing module 503 fills an any-to-any packet into information of protected data stream. Thus, the IPsec SA may be searched out according to the public address.

The processing module 503 is further to when the apparatus is a Spoke device and the public network address is not searched out according to the private address of the next hop, obtain a public network address of a Hub device in the first table, obtain an IPsec SA corresponding to the Hub device in the second table according to the public network address of the Hub device, perform the IPsec encapsulation for the received packet by use of the IPsec SA, and transmit the packet to the Hub device.

The processing module 503 is further to when the apparatus is a Spoke device and the IPsec SA corresponding to the public network address is not searched out in the second table, obtain a public network address of a Hub device in the first table, obtain an IPsec SA corresponding to the Hub device in the second table according to the public network address of the Hub device, perform the IPsec encapsulation for the received packet by use of the IPsec SA, and transmit the packet to the Hub device.

The processing module 503 is further to discard the received packet when the apparatus is a Hub device and the public network address is not searched out according to the private address of the next hop.

The processing module 503 is further to discard the received packet when the apparatus is a Hub device and the IPsec SA corresponding to the public network address is not searched out in the second table.

The receiving module 501 is to receive an IPsec packet from a node device.

The processing module 503 is to when the receiving module 501 receives the IPsec packet, decapsulate the IPsec packet and forward the decapsulated packet according to a target IP address of the decapsulated packet when determining that a target IP address of the received IPsec packet is same with that of the apparatus, forward the IPsec packet according to the target IP address of the IPsec packet when determining that a target IP address of the received IPsec packet is different from that of the apparatus.

Module in the example above may be integrated together, or may be deployed separately, or may be combined into one module, or may be further split into multiple sub-modules.

The apparatus is illustrated according to examples above of the present disclosure. A hardware structure of the apparatus is provided according to the following example of the present disclosure

The apparatus may be a programmable computing device in which hardware is combined with software. FIG. 5 is another schematic diagram illustrating a structure of a DVPN according to an example of the present disclosure. The apparatus includes a processor (e.g., a central processing unit (CPU)) 601, a storage medium such as memory 602. The apparatus may further include another storage medium such as non-volatile memory 603 and other hardware 604.

The memory 602 is to store machine readable instructions. When the instructions are executed, functions of modules such as a receiving module, a searching module and a processing module as shown in FIG. 4 are implemented.

In an example, the memory 602 includes a receiving instruction 6021, a searching instruction 6022 and a processing instruction 6023 respectively executed by the processor 601.

The processor 601 is to communicate with the memory 602 to perform packet transmitting and packet receiving. In an example, the processor 601 is to receive a packet from a node device connecting with the node device or from another node device, transmit a packet to a node device connecting with the node device or to another node device; read and execute the instructions stored in the memory 602 to perform functions of modules such as the searching module, the searching module and the processing module in FIG. 4; and perform processing for the received packet; communicate with the nonvolatile memory 603, write and/or read data stored in the nonvolatile memory 603 including a first table and a second table.

The first table may include at least one entry of a map between a private address and a public address of the next hop, e.g., a section table, a P2P table. The second table may include at least one entry of a map between a public network address and an IPsec SA, e.g., an IPsec table.

The memory 602 includes a receiving instruction 6021, a searching instruction 6022 and a processing instruction 6023. The receiving instruction 6021 is to receive a packet from a node device connecting with the apparatus and another node device obtained the processor 601. The searching instruction 6022 is to search for a public network address of a next hop and an IPsec SA, transmit the IPsec SA searched out to the processing instruction 6033. The processing instruction 6023 is to perform IPsec encapsulation for the received packet by use of the IPsec SA corresponding to the public network address, and forward the received packet. The processing instruction 6023 is to when receiving a packet from another node device transmitted from the receiving instruction 6021, decapsulate the IPsec packet and forward the decapsulated packet through the processor 601; when the searching instruction 6022 does not search out the public network address, trigger to establish a first table and to perform IKE negotiation, establish a second table; when the searching instruction 6022 does not search out the IPsec SA, trigger to establish a second table and store the established first table and the second table into the nonvolatile memory 603.

The nonvolatile memory 603 is to store data including the first table and the second table.

It should be noted that the apparatus in FIG. 5 is merely an example. The apparatus may be implemented with a different structure from that in the example. For example, operations performed when the instructions are executed may be implemented through an application specific IC (ASIC). In addition, the apparatus may have one or more processors 601. When the apparatus has multiple processors 601, the multiple processors 601 take charge of reading and executing the instructions together. Thus, the structure of the apparatus is not limited in the present disclosure.

It can be seen from the above that, in the method, a node device searches a public network address of a next hop in a first table according to a private address of the next hop when receiving a packet transmitted from a device connecting with the node device, the node device searches for an IPsec SA in a second table according to the public network address searched out; and performs IPsec encapsulation for the received packet by use of the IPsec SA. Thus, a size of the packet is reduced and network bandwidth consumption is decreased.

The foregoing is only preferred examples of the present invention and is not used to limit the protection scope of the present invention. Any modification, equivalent substitution and improvement without departing from the spirit and principle of the present invention are within the protection scope of the present invention.

What is claimed is:

1. A method for implementing network communication, comprising:
searching for, by a node device, a public network address of a next hop in a first table according to a private address of the next hop when receiving a packet transmitted from a device connecting with the node device;
searching for, by the node device, an IPsec security association (SA) corresponding to the public network address in a second table according to the public network address searched out; and
performing, by the node device, IPsec encapsulation for the received packet by use of the IPsec SA corresponding to the public network address.

2. The method of claim 1, further comprising:
querying, by the node device, the public network address of the next hop to a control server when the public network address is not searched out from the first table according to the private address of the next hop;
adding, by the node device, an entry of a map between the private network address and the public network address of the next hop into the first table;
performing, by the node device, the IKE negotiation with a node device corresponding to the public network address to obtain the IPsec SA corresponding to the public network address;
adding, by the node device, an entry of a map between the public network address and the obtained IPsec SA into the first table,
wherein the process of performing the IKE negotiation with the node device corresponding to the public network address comprises:
filling information of protected data stream in a negotiation packet with a packet any to any.

3. The method of claim 1, further comprising:
performing, by the node device, the IKE negotiation with a node device corresponding to the public network address to obtain the IPsec SA corresponding to the public network address when the IPsec SA corresponding to the public network address is not searched out in the second table;
adding, by the node device, an entry of a map between the public network address and the IPsec SA into the second table,
wherein the process of performing the IKE negotiation with the node device corresponding to the public network address comprises:
filling information of protected data stream in a negotiation packet with a packet any to any.

4. The method of claim 1, further comprising:
when the node device is a Spoke device and the public network address is not searched out according to the private address of the next hop, obtaining, by the node device, a public network address of a Hub device in the first table;
obtaining, by the node device, an IPsec SA corresponding to the Hub device in the second table according to the public network address of the Hub device;
performing, by the node device, the IPsec encapsulation for the received packet by use of the IPsec SA, and transmitting the packet to the Hub device.

5. The method of claim 1, further comprising:
when the node device is a Spoke device and the IPsec SA corresponding to the public network address is not searched out in the second table, obtaining, by the node device, a public network address of a Hub device in the first table;
obtaining, by the node device, an IPsec SA corresponding to the Hub device in the second table according to the public network address of the Hub device;
performing, by the node device, the IPsec encapsulation for the received packet by use of the IPsec SA, and transmitting the packet to the Hub device.

6. The method of claim 1, further comprising:
discarding the received packet when the node device is a Hub device and the public network address is not searched out according to the private address of the next hop.

7. The method of claim 1, further comprising:
discarding the received packet when the node device is a Hub device and the IPsec SA corresponding to the public network address is not searched out in the second table.

8. The method of claim 1, further comprising:
when receiving an IPsec packet from another node device and determining that a target IP address of the received IPsec packet is same with that of the node device, decapsulating the IPsec packet, and forwarding the decapsulated packet according to a target IP address of the decapsulated packet;
when receiving an IPsec packet from another node device and determining that a target IP address of the received IPsec packet is different from that of the node device, forwarding the IPsec packet according to the target IP address of the IPsec packet;

9. An apparatus for implementing network communication, comprising:
a process for executing instructions stored in a non-transitory machine readable storage medium, the instructions comprise:
a receiving instruction, to receive a packet transmitted from a device connecting with the apparatus;
a searching instruction, to search for a public network address of a next hop in a first table according to a private address of the next hop, search for an IPsec security association (SA) corresponding the public network address in a second table according to the public network address searched out; and
a processing instruction, to perform IPsec encapsulation for the received packet by use of the IPsec SA corresponding to the public network address.

10. The apparatus of claim 9, wherein the processing instruction is further to when the public network address is not searched out from the first table according to the private address of the next hop, query the public network address of the next hop to a control server, add an entry of a map between the private network address and the public network address of the next hop into the first table, perform the IKE negotiation with a node device corresponding to the public network address to obtain the IPsec SA corresponding to the public network address, add an entry of a map between the public network address and the obtained IPsec SA into the first table;
the processing instruction is to fill information of protected data stream in a negotiation packet with a packet any to any.

11. The apparatus of claim 9, wherein the processing instruction is further to when the IPsec SA corresponding to the public network address is not searched out in the second table, perform the IKE negotiation with a node device corresponding to the public network address to obtain the IPsec SA corresponding to the public network address, add an entry of a map between the public network address and the IPsec SA into the second table;
the processing instruction is to fill information of protected data stream in a negotiation packet with a packet any to any.

12. The apparatus of claim 9, wherein the processing instruction is further to when the apparatus is a Spoke device and the public network address is not searched out according to the private address of the next hop, obtain a public network address of a Hub device in the first table, obtain an IPsec SA corresponding to the Hub device in the second table according to the public network address of the Hub device, perform the IPsec encapsulation for the received packet by use of the IPsec SA, and transmit the packet to the Hub device.

13. The apparatus of claim 9, wherein the processing instruction is further to when the apparatus is a Spoke device and the IPsec SA corresponding to the public network address is not searched out in the second table, obtain a public network address of a Hub device in the first table, obtain an IPsec SA corresponding to the Hub device in the second table according to the public network address of the Hub device, perform the IPsec encapsulation for the received packet by use of the IPsec SA, and transmit the packet to the Hub device.

14. The apparatus of claim 9, wherein the processing instruction is further to discard the received packet when the apparatus is a Hub device and the public network address is not searched out according to the private address of the next hop.

15. The apparatus of claim 9, wherein
the receiving instruction is to receive an IPsec packet from a node device;
the processing instruction is to decapsulate the IPsec packet and forward the decapsulated packet according to a target IP address of the decapsulated packet when determining that a target IP address of the received IPsec packet is same with that of the apparatus, forward the IPsec packet according to the target IP address of the IPsec packet when determining that a target IP address of the received IPsec packet is different from that of the apparatus.
